(19) United States
(12) Patent Application Publication
(10) Pub. No.: US 2023/0201920 A1
(43) Pub. Date: Jun. 29, 2023

(54) COMPOSITE WEAR PART

(71) Applicant: MAGOTTEAUX INTERNATIONAL S.A., Vaux-sous-Chèvremont (BE)

(72) Inventor: Guy BERTON, Oteppe (BE)

(21) Appl. No.: 18/000,245

(22) PCT Filed: Mar. 25, 2021
(86) PCT No.: PCT/EP2021/057816

§ 371 Date: Nov. 29, 2022

(30) Foreign Application Priority Data
May 29, 2020 (EP) 20177458.5

(51) Int. Cl. B22F 3/00; B02C 13/28; B22F 3/02; B22D 19/02; B22F 7/06; B22F 1/12; B22D 19/14

(52) U.S. Cl. CPC B22F 3/004; B02C 13/28; B22F 3/02; B22D 19/02; B22F 7/062; B22F 1/12; B22D 19/14; B02C 2210/02; B22F 2007/066; B22F 2302/25; B22F 2303/35; B22F 2998/10

(57) ABSTRACT

The present disclosure relates to a hierarchical wear part including a reinforced portion comprising zirconia or an alumina-zirconia alloy. The reinforced portion also includes centimetric inserts with a predefined geometry. The inserts include micrometric particles of metal carbides, nitrides, borides, or intermetallic compounds bonded by a first metal matrix. The inserts are inserted into a reinforcement structure infiltrated by a second metal matrix, the reinforcement structure having a periodic alternation of millimetric areas of high and low concentration of micrometric particles of zirconia or alumina-zirconia alloy. The second metal matrix is different from the first metal matrix.

### FIELD

The present disclosure relates to a wear part made in a foundry. It relates more particularly to a hierarchical wear part comprising a reinforced portion on the most stressed side thereof.

The present disclosure further describes a method for obtaining said wear part with the reinforcement structure thereof.

### INTRODUCTION

Ore extraction and fragmentation installations, and in particular grinding and crushing equipment, are subject to numerous impact and abrasion resistance stresses.

In the field of aggregate, cement and ore processing, wear parts include vertical shaft crusher impellers and anvils, horizontal shaft crusher hammers and beaters, crusher cones, vertical grinder tables and rollers, lining plates and lifters for ball or bar grinders. Regarding mining extraction installations, we will mention, among others, pumps for oil sands or drilling machines, mining pumps and dredging teeth.

Composite wear parts made by casting in a foundry, comprising portions reinforced by ceramics and infiltrated during the casting, are known from the prior art.

Document EP0575685A1 (Sulzer, 1996) describes a molded part with wear surfaces reinforced by porous ceramic bodies integrated in a metal phase, each ceramic body having a structure in the form of a porous three-dimensional network.

Document WO9815373A1 (Magotteaux, 1997) discloses a composite wear part made in a foundry. It comprises a metal matrix with reinforcements formed by a three-dimensional structure of agglomerated grains comprising a homogeneous phase of 20 to 80% of Al₂O₃ and 80 to 20% of ZrO₂.

Document WO2016008967A1 (Magotteaux, 2015) discloses sintered ceramic grains comprising from 3 to 55% by weight of alumina and from 40 to 95% by weight of zirconia, associated with inorganic components such as rare metal oxides or alkaline earth metal oxides.

The documents according to the prior art cannot, however, be used for obtaining high concentrations of ceramics in the most stressed portions of the part because the three-dimensional structures of aggregates of millimetric grains, during casting, require proportions of interstices which are sufficient for allowing the reinforcement structure to be fully infiltrated by the ferrous alloy during casting, which limits the concentration of ceramics available in the reinforced areas.

### SUMMARY

The present disclosure is aimed at overcoming the drawbacks of the prior art and in particular the difficulty of obtaining reinforcement areas comprising a very high concentration of ceramic particles. It is further aimed at integrating areas with a high concentration of ceramic particles within a three-dimensional structure of aggregated millimetric grains which mainly contain alumina-zirconia, the three-dimensional structure comprising millimetric interstices that can be infiltrated by the casting ferrous alloy. The millimetric grain reinforcement structure makes it also possible to ensure the positioning, in the mold of the wear part, of prefabricated inserts with a defined geometry and concentrated with ceramic particles such as carbides, nitrides, borides or intermetallic elements. The inserts comprise a first metal matrix serving as a binder for the ceramic particles, the first metal matrix being independent of the casting alloy forming the second metal matrix.

The reinforced portion is obtained by placing, in a mold, a reinforcement consisting of an aggregate of millimetric grains with millimetric interstices, in preparation for casting the wear part. The reinforcement further comprises centimetric inserts which are made of ceramics and previously manufactured according to a predefined geometry. The inserts comprise micrometric ceramic particles bonded in a first metal matrix and the millimetric interstices of the reinforcement are infiltrated during the casting by a second metal matrix. The first metal matrix is independent of the second metal matrix. The present disclosure discloses a hierarchical wear part including a reinforced portion comprising zirconia or an alumina-zirconia alloy, said reinforced portion further comprising centimetric inserts with a predefined geometry, said inserts comprising micrometric particles of metal carbides, nitrides, borides or intermetallic compounds bonded by a first metal matrix, said inserts being inserted into a reinforcement structure infiltrated by a second metal matrix, the reinforcement structure comprising a periodic alternation of millimetric areas of high and low concentration of micrometric particles of zirconia or alumina-zirconia alloy, the second metal matrix being different from the first metal matrix.

The preferred embodiments of the present disclosure include at least one or any suitable combination of the following features:
the reinforced portion further comprises millimetric areas of a ceramic-metal composite comprising micrometric particles of titanium carbides, titanium nitrides, or titanium carbonitrides in a binder forming a third metal matrix, the proportion of such areas compared with the millimetric areas with a high concentration of micrometric particles of zirconia or alumina-zirconia alloy being less than 50% by volume, preferably less than 40% by volume and particularly preferably less than 30% by volume, the third metal matrix being independent of the first metal matrix and the second metal matrix;
the insert comprises a concentration of micrometric particles of metal carbides, nitrides, borides or intermetallic elements of between 20 and 95% by volume and at least 30%, preferably at least 40% and particularly preferably at least 50% by volume;
the first metal matrix used as a binder for the micrometric particles of the insert mainly comprises nickel, nickel alloy, cobalt, cobalt alloy or a ferrous alloy which is different from the casting alloy;
the third metal matrix used as a binder for the micrometric particles of titanium carbides, titanium nitrides, or titanium carbonitrides in the millimetric areas which are part of the reinforcement mainly comprises nickel, nickel alloy, cobalt, cobalt alloy or a ferrous alloy which is different from the casting alloy;
the insert or the millimetric areas of the reinforcement when same comprise ceramic-metal composites include micrometric particles of metal carbides, nitrides, borides or particles of intermetallic alloys with a mean size D₅₀ of less than 80 μm, preferably less than 60 μm and particularly preferably less than 40 μm;
the insert and the areas reinforced with zirconia or alumina-zirconia alloy comprise micrometric interstices which include different metal matrices.

The present disclosure further discloses a method for manufacturing a wear part according to the present disclosure, comprising the following steps:
providing a mold comprising the cavity of a wear part with a predefined geometry of an area to be reinforced;
introducing and positioning, in said area to be reinforced, a compact mixture of powders in the form of millimetric granules of zirconia or alumina-zirconia surrounding at least partially one or several inserts with a defined geometry, which are prefabricated and concentrated in micrometric particles of metal carbides, nitrides, borides or in intermetallic compounds bonded by a first metal matrix;
casting a ferrous alloy into the mold, said liquid ferrous alloy infiltrating the three-dimensional structure which comprises grains of zirconia or alumina-zirconia alloy at least partially surrounding the prefabricated inserts.

According to a preferred embodiment of the method according to the present disclosure, the inserts with a predefined geometry manufactured prior to the casting of said wear part are manufactured by powder metallurgy.

The present disclosure further discloses the present disclosure in the form of an impactor, an anvil, a cone or a grinding roller.

### BRIEF DESCRIPTION OF THE DRAWINGS

FIG. 1 schematically shows a wear part with an area reinforced by a reinforcement comprising prefabricated cylindrical inserts made of ceramics and surrounded by a structure of aggregated millimetric grains containing zirconia or alumina-zirconia infiltrated by the casting metal.

FIG. 2 schematically shows the detail of a reinforcement according to the present disclosure, consisting of prefabricated cylindrical inserts made of ceramics and set in a structure of millimetric grains containing zirconia or alumina-zirconia.

FIG. 3 schematically shows a horizontal shaft crusher beater with the predefined area reinforced by prefabricated cylindrical inserts made of ceramics and surrounded by a structure of millimetric grains of zirconia or alumina-zirconia with infiltrable porosity and millimetric interstices.

FIG. 4 schematically shows a vertical grinder roller with the predefined area reinforced by prefabricated cylindrical inserts made of ceramics and surrounded by a structure of millimetric grains of zirconia or alumina-zirconia with infiltrable porosity and millimetric interstices.

FIG. 5 schematically shows a vertical shaft crusher anvil with the predefined area reinforced by prefabricated cylindrical inserts made of ceramics and surrounded by a structure of millimetric grains of zirconia or alumina-zirconia with infiltrable porosity and millimetric interstices.

FIG. 6 schematically shows the method for measuring the Feret diameter (with the minimum and maximum Feret diameters). The Feret diameters are used in the method to obtain the mean size of the ceramic-metal particles (as explained hereinafter).

FIG. 7 is a graph of Vickers Hardness vs. percent zirconia in alumina.

FIG. 8 is a graph of toughness vs. percent zirconia in alumina.

FIG. 9 is a graph of toughness vs. hardness for an illustrative family of materials.

FIG. 10 is the graph of FIG. 9 reflecting movement of the toughness vs. hardness curve to achieve higher hardnesses for an equivalent toughness.

### LIST OF REFERENCE SYMBOLS

1: composite wear part reinforced by a ceramic composition at the locations which are most exposed to wear.
2: reinforcement structure with a predefined geometry infiltrated by the casting metal (second metal matrix), the structure comprising millimetric grains of alumina-zirconia with infiltrable porosity and millimetric interstices.
3: prefabricated ceramic-metal composite insert comprising, as a binder for the ceramic particles containing carbides, nitrides, borides and intermetallic elements, a first metal matrix different from the casting metal, the insert being integrated into the infiltrable structure, the whole structure being placed in the mold before casting.
4: detail of a reinforcement structure showing a millimetric interstice with an area containing a low concentration of ceramic particles. The interstice is mainly occupied by the second metal matrix, the casting metal.
5: detail of a reinforcement structure schematically showing a millimetric area with a high concentration of ceramic particles resulting from the aggregate of millimetric grains infiltrated by the second metal matrix, the casting metal.
6: casting metal (second metal matrix).
7: alumina in a millimetric grain forming the infiltrable porous structure.
8: zirconia in a millimetric grain forming the infiltrable porous structure.

References 7 and 8 show an alloy of alumina-zirconia particles.
9: prefabricated ceramic particles which can represent up to 90% of the total volume of the insert. The inserts can be manufactured by any technology but are preferably manufactured by powder metallurgy.
10: first metal matrix specific for the ceramic insert. This metal matrix, which is used as a binder for the particles of carbides, nitrides, borides and intermetallic elements, is independent of the second metal matrix resulting from the casting which infiltrates the infiltrable structure containing zirconia and/or alumina-zirconia.
13: beater of a horizontal shaft crusher comprising a reinforced structure according to the present disclosure.
14: roller of a vertical grinder comprising a reinforced structure according to the present disclosure.
15: anvil of a vertical shaft crusher comprising a reinforced structure according to the present disclosure.

### DETAILED DESCRIPTION

The present disclosure discloses a wear part with increased wear resistance, made in a conventional foundry. It relates more particularly to a wear part comprising a reinforced portion according to a predefined geometry with ceramic inserts (cylinders, polygons, cones, etc.) on the scale of a few centimeters, manufactured beforehand and inserted into an infiltrated three-dimensional structure made of agglomerated millimetric grains and forming a periodic alternation of grains and millimetric interstices.

The grains used to produce the three-dimensional structure mainly comprise ZrO₂ zirconia or alumina-zirconia, the composition of which can range from 5 to 95% by weight of alumina and from 95 to 5% of zirconia, preferably 10 to 90% and 90 to 10%, and particularly preferably 20 to 80% and 80 to 20%. In addition to such ingredients, the grains can comprise stabilizers such as rare earth oxides, in particular yttrium oxide or cerium oxide as stabilizers for zirconia.

The millimetric grains used for producing the three-dimensional reinforcement structure may further comprise, in a proportion which is less than 50%, preferably less than 40% and particularly preferably less than 30% by volume, titanium carbides, titanium nitrides or titanium carbonitrides in a third metal matrix which is also independent of the first two matrices (not shown in the figures). The third metal matrix used as a binder for these millimetric grains preferably contains iron alloy, nickel alloy or molybdenum alloy. The volumetric proportion of the metallic binder (third metallic matrix) is usually comprised between 5 and 60%, preferably between 7 and 45% and particularly preferably between 10 and 35%. The size of the titanium carbides, nitrides or carbonitrides ranges from 0.05 to 75 μm, preferably from 0.2 to 40 μm, more preferably from 0.5 to 15 μm.

The infiltrable structure is thus made of a three-dimensional structure of an aggregate of millimetric grains with a mean size comprised between 0.5 and 10 mm, preferably between 0.7 to 6 mm and particularly preferably between 1 and 4 mm. The interstices between the grains depend on the degree of compaction and on the size of the grains, but are of about a millimeter or a fraction of a millimeter. There is thus a “periodic” alternation of grains and interstices and not a “random” alternation.

The millimetric grains comprise a homogeneous mixture containing zirconia or alumina-zirconia and can be agglomerated/compacted together by means of a binder (glue) or held in a metal container so as to geometrically define the reinforced area of the wear part.

The use of a binder with setting through the addition of a catalyst allows the production of the infiltrable structure without curing, which might be a preferred solution in some cases where suitable curing means are not available. The nature of the binder is then either of the organic or mineral type, preferably of the organic type, more preferably of the phenolic type.

The use of a binder with setting by curing makes it possible to use a binder which is more resistant at high temperature. The nature of the binder is then of the mineral type, preferably of the silicate type, more preferably of the sodium silicate type.

The quantity of binder (glue) used for producing the infiltrable structure is comprised between 0.5% and 10% by weight, preferably between 1% and 8%, more preferably between 1.5% and 7%. The quantity of binder is adapted so as to provide sufficient grain cohesion, limit the production of gas during the infiltration by the liquid casting metal, and minimize the residual thickness of binder around each grain forming the porous three-dimensional structure.

The ceramic inserts intended for being held by the three-dimensional structure of agglomerated grains may have any shape, cylindrical, polygonal or conical shapes being, however, preferred. The diameter of these ceramic inserts, in the case of a cylindrical shape, is of about 3 to 50 mm, preferably 6 to 30 mm, more particularly 8 to 20 mm and their length ranges from 5 to 300 mm, preferably from 10 to 200 mm, in particular from 10 to 150 mm.

The present disclosure thus describes a wear part which is reinforced on the most stressed side or sides thereof and obtained by the infiltration of a three-dimensional ceramic structure of agglomerated millimetric grains alternating periodically with millimetric interstices, the structure already incorporating prefabricated geometric inserts in ceramics of the ceramic-metal composite type usually obtained by powder metallurgy, in which the ceramic particles are embedded in a first metal matrix completely independent of the second metal casting matrix, which is mainly made of steel or liquid cast iron.

This technique can be used for a convenient and firm positioning of inserts with a defined geometry and concentrated in metal carbides, nitrides, borides or in intermetallic alloys comprising a metal matrix independent of the matrix generated by the casting. This first metal matrix, which exists prior to the casting of said wear part, is present in the ceramic-metal composite inserts from the start. The pre-existing inserts are integrated into an infiltrable structure comprising agglomerated millimetric grains (padding) of zirconia, alumina-zirconia or ceramic-metal composite which are infiltrated during the casting of the wear part. The infiltrable three-dimensional structure may further comprise a certain proportion of millimetric grains of titanium carbides, titanium nitrides or titanium carbonitrides in a third metal matrix independent of the first two.

Contrary to what is practiced in the prior art, ceramic-metal composite inserts, such as a cylindrical or frustoconical insert, are here partially used. This insert can consist e.g. of titanium carbides, titanium nitrides or chromium carbides with a minimum concentration of 40% by volume in a first metal matrix containing for example iron, manganese, nickel or cobalt, which is “wrapped” in an infiltrable structure made for example of an agglomerate of millimetric grains containing zirconia or alumina-zirconia. For certain conditions of use, this infiltrable structure may further comprise millimetric grains of metal carbides, nitrides, borides or intermetallic elements, preferably titanium carbide, titanium nitride or titanium carbonitride.

Alumina is known for its low-load abrasion resistance properties owing to its high hardness compared with the hardness of the main natural minerals. Alumina also benefits from a low density and low implementation costs, whether by melting or by powder sintering.

As for pure zirconia, same is generally used in the presence of stabilizers. Zirconia, in its tetragonal crystallographic form, has interesting mechanical properties for the reinforcement of wear-stressed parts. The addition of between 0.3 and 8% of rare earth oxide such as yttrium oxide or cerium oxide allows zirconia to be stabilized in its tetragonal phase.

Zirconia has higher flexural strength and toughness than alumina. The ability of tetragonal zirconia to transform into a less dense monoclinic, crystallographic form and thus to close the crack front, if any, gives the material high toughness and mechanical strength. The wear resistance of zirconia is particularly good in the case where the surface stresses induced by abrasive particles are high. On the other hand, its hardness, which is lower compared with certain natural minerals, including quartz or free silica, limits its use when same is stressed by ores containing said minerals.

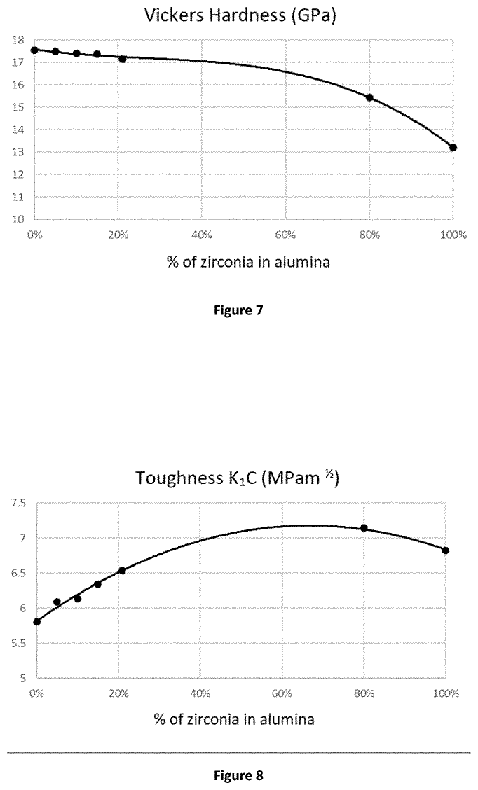

The production of alumina-zirconia composites makes it possible to improve the properties of the two compounds taken separately, in particular, their mechanical strength and toughness. The evolution of such properties is shown in the following figures. The choice of the proportion of zirconia in the alumina is used for optimizing the hardness/toughness-mechanical properties pair depending on the wear stresses which the material is subject to, so as to obtain the best performance of the part thus reinforced. See FIGS. 7-8.

The present disclosure can thus be used not only for achieving very high concentrations of ceramics, generally greater than 40% by volume and which may reach up to 95% by volume in the prefabricated geometric inserts or preexisting millimetric grains of ceramic-metal composite, but also for choosing the specific metal matrix (first and third metal matrix) for such elements and thus for being independent of the casting metal (second metal matrix) of the wear part which is usually cast iron or chromium steel.

The present disclosure increases the performance of the reinforced wear parts made in a foundry compared with the wear parts of the prior art thanks to the localized increase in the wear resistance of the area reinforced by the presence of a higher number of wear-resistant particles and/or particles of a different nature, by means of a more suitable metal matrix. Same further provides better performance of the manufactured wear parts by adding areas with a defined geometry concentrated in metal carbides, nitrides, borides or intermetallic alloys and a metal matrix which is there prior to the casting of said wear part, by avoiding the preferential wear of the ferrous alloy of the wear part around these areas owing to the structure alternating, on a millimetric scale, areas thick with fine ceramic particles with areas practically free of same within the metal matrix of the part, in the vicinity of the “wrapping” structure of the pre-existing ceramic inserts, while improving the cohesion of these inserts with the ferrous alloy of the reinforced wear part.

### Measurement Method

### Mean Size of the Particles of Metal Carbides, Nitrides, Borides or Intermetallic Alloys

The calculation of the mean size d₅₀ of the particles of metal carbides, nitrides, borides or particles of intermetallic alloys is performed through the following steps.

First, a photomicrographic panorama of the polished cross-section of a sample is made, so that there are at least 250 complete particles across the field of view. The panorama is performed by stitching (a process of combining a series of digital images of different parts of a subject into a panoramic view of the whole subject so as to maintain good definition) using a computer program and an optical microscope (e.g., a general image field panorama obtained by an Alicona Infinite Focus).

An appropriate thresholding is then carried out for segmenting the image into features of interest (the particles) and background, in different levels of grey. If the thresholding is inconsistent due to poor image quality, a manual step of drawing particles, the scale bar if present, and the frame of the image on tracing paper is added, as well as a step of scanning the tracing paper.

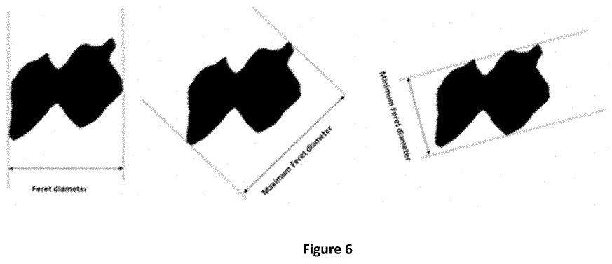

The Feret diameter (which corresponds to the distance between two parallel tangents, placed perpendicular to the measurement direction in such a way that the entire projection of the particle lies between the two tangents) is measured by an image analysis software (e.g. ImageJ) for each particle, in all directions. An example is shown in FIG. 6.

The minimum and maximum Feret diameters are then determined for each particle in the image. The minimum Feret diameter is the smallest diameter of the set of Feret diameters measured for a particle. The maximum Feret diameter is the largest diameter of the set of Feret diameters measured for a particle. Particles touching the edges of the image are ignored in the calculation.

The mean value of the minimum and maximum Feret diameters of each particle is taken as an equivalent diameter x. The volume distribution of the particle sizes q₃ (x) is then calculated based on spheres of diameter x.

The mean particle size d₅₀ is the volume-weighted mean size x̅_{1,3} according to the standard ISO 9276-2: 2014.

### EXAMPLES

### Comparative Example

In the present example, the resistance of a reinforced wear part according to the prior art is measured. The wear part is manufactured similarly to the method disclosed in prior art WO9815373A1 (Magotteaux, 1997).

The wear part is a vertical shaft impactor part reinforced by a porous and infiltrable three-dimensional structure of agglomerated millimetric grains. The volume of the wear part is 10.27 dm³. Its weight is 74.16 kg.

To evaluate the degree of wear, the overall weight loss of the vertical shaft impactor part is measured. In practice, this is the only way to determine wear, which depends on a series of factors and, in particular, on the positioning geometry in the impactor. Although the impactor is mostly worn on the side of the reinforcement, the impactor is also partially worn outside the reinforcement depending on the positioning.

In the three-dimensional structure according to the prior art, there is an alternation between millimetric grains and interstices. These grains consist of electrofused alumina-zirconia agglomerated with 3.5% by weight of mineral binder of the sodium silicate type. The composition of the electrofused alumina-zirconia grains is described hereinafter.

| Alumina | Zirconia | Yttrium |
|---|---|---|
| (% wt) | (% wt) | oxide |
| 59 | 40 | 0.80 |

This infiltrable structure comprises an aggregate of millimetric grains with an average size of about 2.5 mm. The grains are agglomerated according to a predefined shape in a three-dimensional structure using sodium silicate in a resin mold. In this three-dimensional structure, there is an alternation between millimetric grains and interstices.

The comparative example thus comprises reinforced portions containing alumina-zirconia, on the most stressed side of the wear part without initially containing centimetric inserts in ceramic-metal composite, for example of the cylinder type, positioned beforehand in a metal matrix which is different from the ferrous alloy used for the casting. At the end of these steps, a shape with a total reinforced volume of 0.857 dm³ is manufactured. The weight loss observed during a wear test is 6.795 kg per 100 hours of operation (kg/100 h) on the wear part of the vertical shaft impactor.

### Examples According to the Present Disclosure

### Example 1

The reinforced part according to the present disclosure comprises a reinforced area with a predefined geometry and cylindrical ceramic inserts manufactured beforehand on a scale of a few centimeters and previously inserted into an infiltrable structure comprising grains containing electrofused alumina-zirconia with the composition described hereinafter. It should be noted that these grains have the same characteristics as those of the comparative example.

| Alumina | Zirconia | Yttrium |
|---|---|---|
| (% wt) | (% wt) | oxide |
| 59 | 40 | 0.80 |

The infiltrable structure comprises an aggregate of millimetric grains with a mean size of about 2.5 mm. The grains are agglomerated according to a predefined shape in a three-dimensional structure using a sodium silicate glue in a resin mold. In the three-dimensional structure, there is a periodic alternation between millimetric grains and interstices.

The ceramic inserts previously manufactured have a cylindrical geometric shape and consist on average of 70 to 80% of micrometric particles of titanium carbides bonded by a first metal matrix of the austenitic steel type.

The diameter of the ceramic inserts manufactured beforehand is 20 mm. The height is 30 mm.

Prior to the addition of the millimetric grains of alumina-zirconia, the 25 ceramic inserts manufactured beforehand are positioned vertically relative to the filling face in a predefined manner in the resin mold, which defines the reinforcement area by means of notches made in the resin mold.

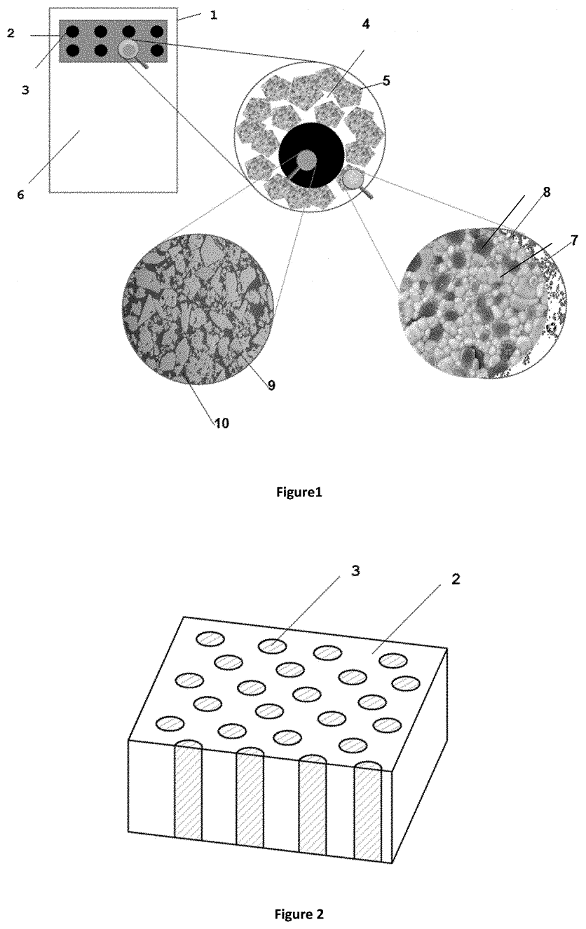

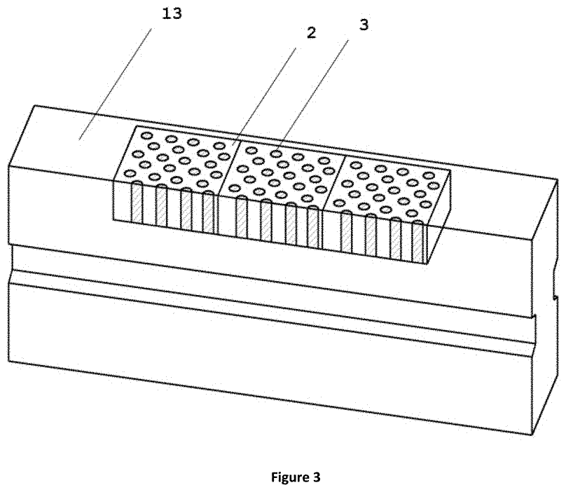

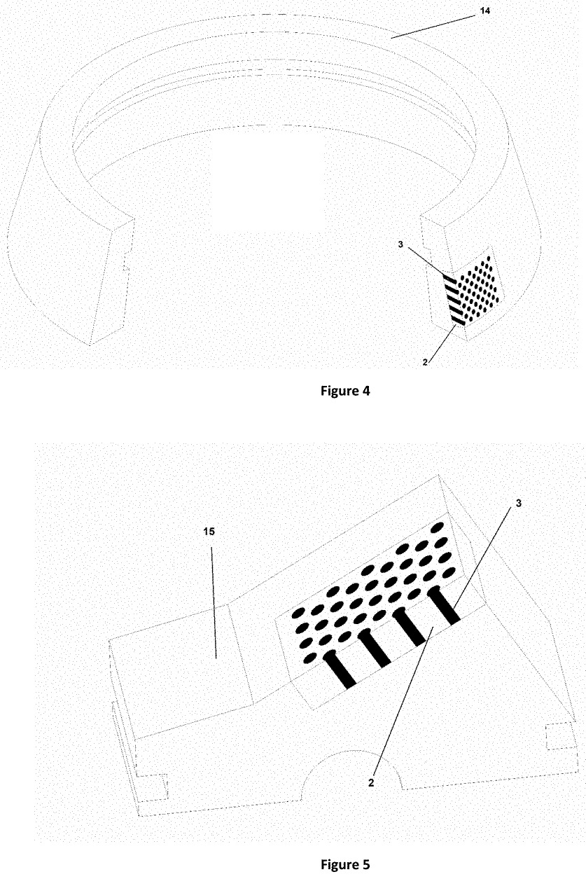

Following such steps, a three-dimensional structure with a total volume of 0.857 dm³, similar to FIG. 2, is manufactured by casting an AFNOR Z 270 C 27—M cast iron. This type of cast iron, which forms the second metal matrix, is used in all the examples.

| | |
|---|---|
| Ex 1 (25 | 25 preformed ceramic-metal composite inserts with |
| preformed | titanium carbide particles (70-80% vol) bonded in a |
| inserts) | first austenitic steel metal matrix, the inserts being |
| | surrounded by millimetric grains of electrofused |
| | alumina-zirconia (Al₂O₃—ZrO₂) |
| Weight loss (kg/100 h) | 5.022 kg |

### Example 2

Example 1 is repeated, but this time, 25 ceramic inserts manufactured beforehand are positioned in the same manner as in example 1, but consist on average of 70 to 80% of micrometric particles of titanium carbides and of a first metal matrix of nickel alloy.

| | |
|---|---|
| Ex. 2 (25 | 25 preformed ceramic-metal composite inserts |
| preformed | with titanium carbide particles (70-80% vol) |
| inserts) | bonded in a first metal matrix |
| | of nickel alloy, surrounded by millimetric grains of |
| | electrofused alumina-zirconia (Al₂O₃—ZrO₂) |
| Weight loss | 5.125 kg |
| per 100 hours | |
| (kg/100 h) | |

### Example 3

Example 1 is repeated with 25 inserts, but this time the ceramic-metal composite inserts manufactured beforehand comprise on average 75 to 85% of micrometric particles of titanium carbonitrides and a first metal matrix containing a molybdenum alloy.

| | |
|---|---|
| Ex. 3 (25 | 25 preformed centimetric metal-ceramic |
| preformed inserts) | composite inserts with particles of titanium |
| | carbonitride (75-85% vol) bonded in a first |
| | molybdenum metal matrix, surrounded by |
| | millimetric grains of electrofused alumina- |
| | zirconia (Al₂O₃—ZrO₂) |
| Weight loss per | 4.921 kg |
| 100 hours (kg/100 h) | |

### Example 4

Example 1 is repeated, again with 25 inserts of the same size, but the ceramic inserts manufactured beforehand comprise on average 80 to 90% of micrometric particles of chromium carbides bonded in a first metal matrix containing nickel.

| | |
|---|---|
| Ex. 4 (25 | 25 preformed centimetric inserts with particles of |
| preformed inserts) | chromium carbides (80-90% vol) bonded with a |
| | nickel-based binder, surrounded by millimetric |
| | grains of electrofused alumina-zirconia |
| | (Al₂O₃—ZrO₂) |
| Weight loss | 6.123 kg |
| per 100 hours | |
| (kg/100 h) | |

### Example 5

Example 4 is repeated, again with 25 inserts of the same size, and the ceramic inserts manufactured beforehand comprise on average 80 to 90% of micrometric particles of chromium carbides bonded in a first metal matrix containing nickel.

This time, the three-dimensional structure surrounding the centimetric inserts comprises 25% by volume of millimetric grains comprising on average 80 to 85% of micrometric particles of titanium carbonitrides in a third metallic matrix containing a molybdenum alloy.

| | |
|---|---|
| Ex. 5 (25 | 25 preformed centimetric inserts in particles of |
| preformed inserts) | chromium carbides (80-90% vol) bonded with a |
| | nickel-based binder, surrounded by millimetric |
| | grains of electrofused alumina-zirconia |
| | (Al₂O₃—ZrO₂) comprising a proportion of |
| | 25% by volume of millimetric grains of |
| | titanium carbonitrides |
| Weight loss per | 6.13 kg |
| 100 hours (kg/100 h) | |

### Summary Table and Interpretation of the Results

The table hereinafter shows the weight losses of a wear part of a 74.16 kg vertical shaft impactor in new condition, the reinforced volume of which represents about 0.857 dm³. The weight loss is measured after 438 hours of operation and is reduced to 100 hours of operation.

| | | | Num- | Com- | |
|---|---|---|---|---|---|
| | | | ber | posite | |
| | Reinforcement | | of | impactor | |
| | surrounding the | | pre- | wear | |
| | preformed | | formed | (kg/ | Gain |
| Ex | insert | Preformed insert | inserts | 100 h) | % |
| C. | Electrofused | — | — | 6.795 | — |
| | alumina-zirconia | | | | |
| 1 | Millimetric grains | Titanium carbide (70- | 25 | 5.022 | 35.3 |
| | of electrofused | 80 vol %) bonded with | | | |
| | alumina-zirconia | austenitic steel | | | |
| 2 | Millimetric grains | Titanium carbide (70- | 25 | 5.125 | 32.6 |
| | of electrofused | 80 vol %) bonded with a | | | |
| | alumina-zirconia | nickel alloy | | | |
| 3 | Millimetric grains | Titanium carbonitride | 25 | 4.921 | 38.1 |
| | of electrofused | (75-85 vol %) bonded | | | |
| | alumina-zirconia | with a molybdenum- | | | |
| | | based alloy | | | |
| 4 | Millimetric grains | Chromium carbides (80- | 25 | 6.123 | 11.2 |
| | of electrofused | 90 vol %) bonded with a | | | |
| | alumina-zirconia | nickel-based alloy | | | |
| 5 | Millimetric grains | Chromium carbides (80- | 25 | 6.130 | 11.1 |
| | of electrofused | 90 vol %) bonded with a | | | |
| | alumina-zirconia + | nickel-based binder | | | |
| | 25% vol of | | | | |
| | titanium | | | | |
| | carbonitride | | | | |
| | grains | | | | |

### Interpretation of the Results

The examples previously described show that the wear performance of the wear part of a vertical shaft impactor is, compared with the prior art, improved by adding centimetric inserts with a predefined geometry in a porous three-dimensional structure consisting of millimetric grains.

The wear mechanisms of the wear parts of vertical shaft impactors are a complex mixture of material tearing by abrasion, micro-peeling by microcrack propagation and impact erosion of the treated particles.

Under such complex operating conditions, the wear behavior of a material depends on a large number of parameters which are interdependent. Among the most significant parameters are hardness, toughness, the modulus of elasticity, the mean free path between the different particles at different scales (micrometric, millimetric, centimetric) depending on the size and shape of the treated particles, elastic limit, fatigue resistance and ductility.

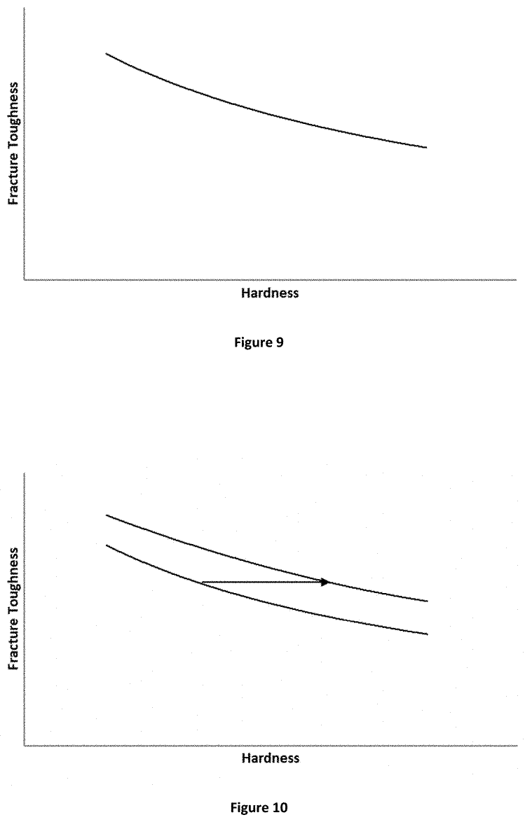

In a simplified approach, the higher the hardness*toughness product, the better the material resistance to wear. These two properties are intimately linked for a same family of materials, as shown in the FIG. 9.

The development of composite materials makes it possible to advantageously move this curve toward higher hardnesses for an equivalent toughness, as depicted in FIG. 10.

The optimization of the geometric distribution of the materials forming the composite, coupled to their nature and thus to their intrinsic properties, can be used for further increasing the overall hardness of the material while maintaining sufficient toughness, leading to better wear performance.

1. A hierarchical wear part including:
a reinforced portion comprising zirconia or an alumina-zirconia alloy, said reinforced portion further comprising centimetric inserts having a predefined geometry,
said inserts comprising micrometric particles of metal carbides, nitrides, borides, or intermetallic compounds bonded by a first metal matrix,
said inserts being inserted into a reinforcement structure infiltrated by a second metal matrix, the reinforcement structure comprising a periodic alternation of millimetric areas of higher and lower concentration of micrometric particles of zirconia or alumina-zirconia alloy;
wherein the second metal matrix is different from the first metal matrix.

2. The wear part according to claim 1, wherein the reinforced portion further comprises millimetric areas of ceramic-metal composite comprising micrometric particles of titanium carbides, titanium nitrides, or titanium carbonitrides in a binder forming a third metal matrix, a proportion of such areas compared with the millimetric areas paving a higher concentration of micrometric particles of zirconia or alumina-zirconia alloy being less than 50% by volume, wherein the third metal matrix is independent of the first metal matrix and the second metal matrix.

3. The wear part according to claim 1, wherein the insert comprises a concentration of the micrometric particles of metal carbides, nitrides, borides, or intermetallic elements of between 20% and 95% by volume.

4. The wear part according to claim 1, wherein a majority of the first metal matrix used as a binder for the micrometric particles of the insert comprises nickel, nickel alloy, cobalt, cobalt alloy, or a ferrous alloy different from the casting alloy.

5. The wear part according to claim 1, wherein a majority of the third metal matrix used as a binder for the micrometric particles of titanium carbides, titanium nitrides, or titanium carbonitrides in the millimetric areas which are part of the reinforcement comprises nickel, nickel alloy, cobalt, cobalt alloy, or a ferrous alloy different from the casting alloy.

6. The wear part according to claim 1, wherein the insert or the millimetric areas of the reinforcement, when same comprise ceramic-metal composites, include particles of metal carbides, nitrides, borides, or particles of intermetallic alloys with a mean size D₅₀ of less than 80 μm.

7. The wear part according to claim 1, wherein the insert and the areas reinforced with zirconia or alumina-zirconia alloy comprise micrometric interstices having different metal matrices.

8. The wear part according to claim 1, manufactured in the form of an impactor, an anvil, a cone or a grinding roller.

9. A method for manufacturing the wear part according to claim 1, the method comprising the following steps:
providing a mold comprising the cavity of the wear part having a predefined geometry of an area to be reinforced,
introducing and positioning, in said area to be reinforced, a compact mixture of powders in the form of millimetric granules of zirconia or alumina-zirconia surrounding at least partially one or several inserts having a defined geometry, which are prefabricated and concentrated in micrometric particles of metal carbides, nitrides, borides, or in intermetallic compounds bonded by a first metal matrix,
casting a liquid ferrous alloy into the mold, said liquid ferrous alloy infiltrating the three-dimensional structure comprising grains of zirconia or alumina-zirconia alloy at least partially surrounding the prefabricated inserts.

10. The method according to claim 9, wherein the inserts with a predefined geometry manufactured prior to the casting of said wear part are manufactured by powder metallurgy.
